(19) United States
(12) Patent Application Publication
(10) Pub. No.: US 2025/0043754 A1
(43) Pub. Date: Feb. 6, 2025

(54) MOBILE DOSING UNIT

(71) Applicant: John S. MYKLEBY, Palos Park, IL (US)

(72) Inventor: John S. MYKLEBY, Palos Park, IL (US)

(21) Appl. No.: 18/788,640

(22) Filed: Jul. 30, 2024

Related U.S. Application Data
(60) Provisional application No. 63/529,995, filed on Jul. 31, 2023.

(51) Int. Cl. F02M 25/00; F02B 47/00; F04B 13/00

(52) U.S. Cl. CPC F02M 25/00; F02B 47/00; F04B 13/00

(57) ABSTRACT

A dosing system that is configured to pre-dose an additive into the fuel tank of a motor vehicle before or during filling, of the vehicle fuel tank. The dosing system includes a base unit having an enclosure that includes a controller, product reservoir and a pump. The dosing system also includes a dynamic fill adapter that is attached to the filler neck of the fuel tank. The tank of base unit is fluidly coupled to the fill adapter. Removal of the cap from the fill adapter causes a predetermined dose of additive to be dispensed from the product reservoir into the fuel tank through the fill adapter.

### CROSS REFERENCE TO RELATED APPLICATION

This application claims priority under 35 U.S.C. § 119(e) to U.S. Provisional Application Ser. No. 63/529,995 filed Jul. 31, 2023, which is expressly incorporated herein by reference in its entirety.

### FIELD OF THE DISCLOSURE

The present disclosure relates generally to dosing systems and specifically dosing systems for vehicles.

### BACKGROUND

It is known to provide a fuel system for a vehicle, such as a semi-tractor and trailer combination, which may include a fuel tank, fuel pump, a fuel filter, a fuel pressure regulator, a fuel rail, and fuel injectors, among other components. Such vehicles may need fuel additives to assist with the efficiency and performance of the vehicle. Additives are typically manually added by a user during fuel stops and fill ups. Oftentimes the user will either add the incorrect amount of additive or forget to add the additive altogether.

### SUMMARY

The present disclosure may comprise one or more of the following features and combinations thereof.

In illustrative embodiments, the present disclosure is directed to a non-invasive fuel treatment device that automatically doses an additive into a vehicle fuel tank or tanks without modification to any part of the drivetrain, fuel lines, or fuel tanks of the vehicle. The dosing unit is configured to be mounted to the vehicle, such as the back of a truck cab, using fasteners. No additional invasive mounting points are required on the cab or elsewhere on the vehicle. Power for the dosing unit is provided by the vehicle's battery or onboard battery.

In illustrative embodiments, the dosing unit accommodates any size of fuel tank including trucks and other vehicles fitted with varied sized or number of fuel tanks including saddlebacks, and the reservoir of the dosing unit may be refilled during oil changes or other routine vehicle maintenance. The dosing unit automatically pre-doses additives directly into the fuel tanks prior or during fill up with no driver involvement and can be used to dose stationary tanks as well, without driver or tank refill personnel involvement.

In illustrative embodiments, the dosing unit pre-doses into the fuel tank before filling, allowing the fuel fill stream to provide superior additive mix with the fuel as well as superior activation agitation. The dosing system includes a dynamic fill adapter that is attached to the filler neck of the fuel tank by use of factory threads or clamp on design. The dosing system and dynamic fill adapter are non-invasive to both the OEM drive train system and the OEM fuel system. No driver or operator intervention is required other than service personnel maintaining additives in the storage reservoir. The dosing system achieves any combination of separately unique features comprising fully automatic pre-dosing, non-invasive installation, appropriately measured pre-dosing, superior fuel mix, greatly improved agitating activation properties, with no driver or operator intervention required.

The foregoing summary is illustrative only and is not intended to be in any way limiting. In addition to the illustrative embodiments and features described herein, further aspects, embodiments, objects and features of the disclosure will become fully apparent from the drawings and the detailed description and the claims.

Additional features of the disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The foregoing and other features of the present disclosure will become more fully apparent from the following description and appended claims, taken in conjunction with the accompanying drawings. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawing, can be arranged, substituted, combined, and designed in a wide variety of different configurations, all of which are explicitly contemplated and make part of this disclosure.

The detailed description particularly refers to the accompanying figures in which:

FIG. 1 is a perspective view of a dosing system showing the base unit, a pair of umbilical cords, a pair of dynamic fuel adapters, and caps;

FIG. 2 is a perspective view of the base unit;

FIG. 3 is a perspective view of the base unit showing the controller, reservoir tanks, and pumps;

FIG. 4 is a perspective view of a semi-tractor showing a saddle fuel tank with fuel cap;

FIG. 5 is a perspective view of a pair of dynamic fuel adapters showing one with a threaded fitting and one with a twist lock fitting;

FIG. 6 is a perspective view of the bottom of the dynamic fuel adapter;

FIG. 7 is another perspective view of the dynamic fuel adapters of FIG. 5;

FIG. 8 is a perspective view of a pair of dynamic fuel adapters;

FIG. 9 is a perspective view of the dynamic fuel adapter showing the fuel cap contact switch and port for connecting an umbilical cord for dispensing additive;

FIG. 10 is a sectional view of FIG. 9 showing a central bore for the fuel nozzle and an internal passageway for additive to flow from the umbilical cord to the fuel tank;

FIG. 11 is a perspective view of the dynamic fuel adapter showing a recess formed in the side wall configured to accept the fuel cap contact switch;

FIG. 12 is a perspective view of the dynamic fuel adapter; and

FIG. 13 is a side elevational view of the dynamic fuel adapter.

### DETAILED DESCRIPTION

The following detailed description is directed to certain specific embodiments of the technology. In this description, reference is made to the drawings wherein like parts or steps may be designated with like numerals throughout for clarity. Reference in this specification to “one embodiment,” “an embodiment,” or “in some embodiments” means that a particular feature, structure, or characteristic described in connection with the embodiment is included in at least one embodiment of the invention. The appearances of the phrases “one embodiment,” “an embodiment,” or “in some embodiments” in various places in the specification are not necessarily all referring to the same embodiment, nor are separate or alternative embodiments necessarily mutually exclusive of other embodiments. Moreover, various features are described which may be exhibited by some embodiments and not by others. Similarly, various requirements are described which may be requirements for some embodiments but may not be requirements for other embodiments.

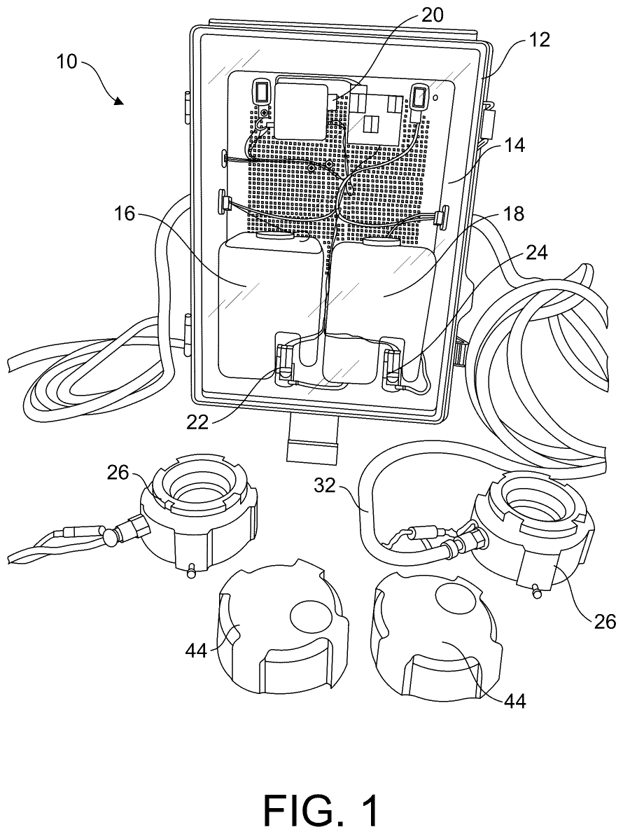

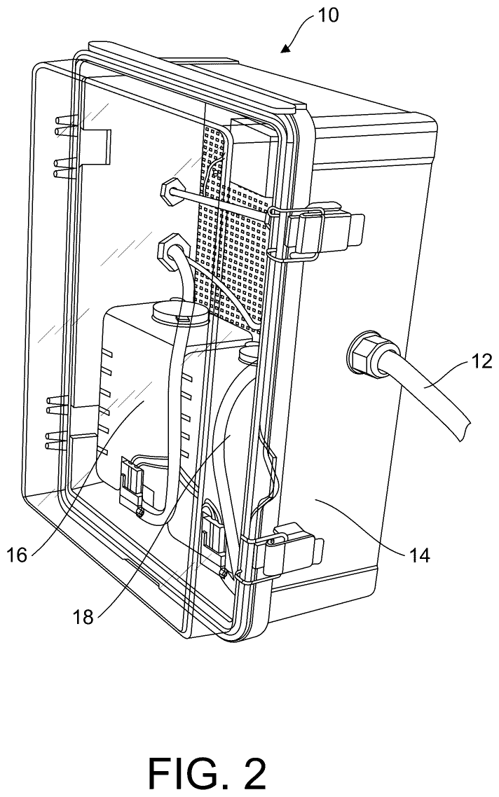

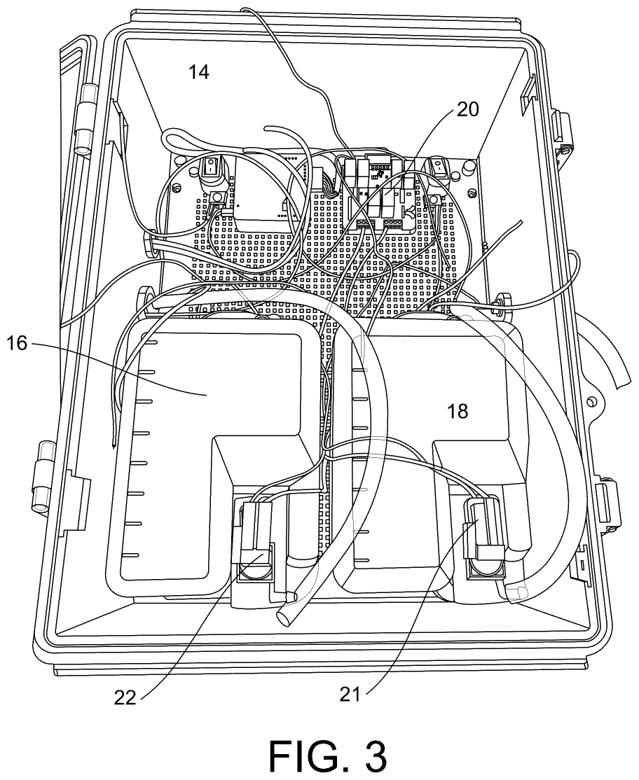

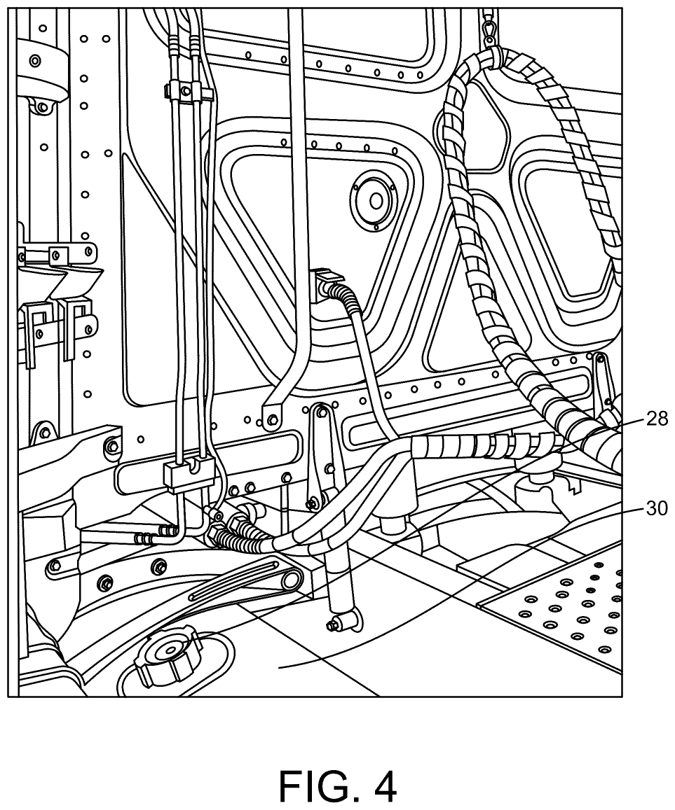

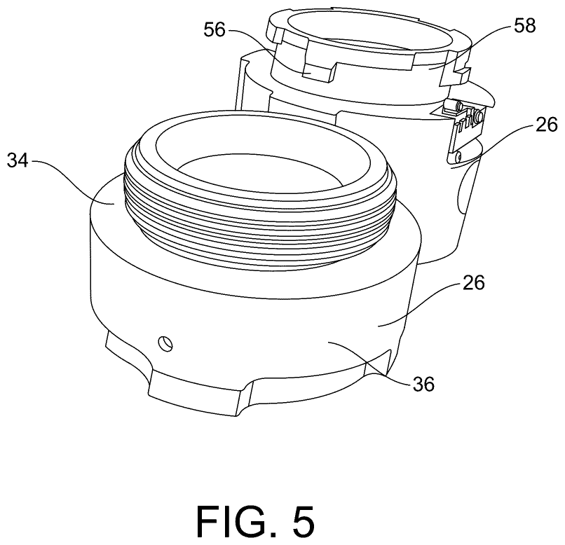

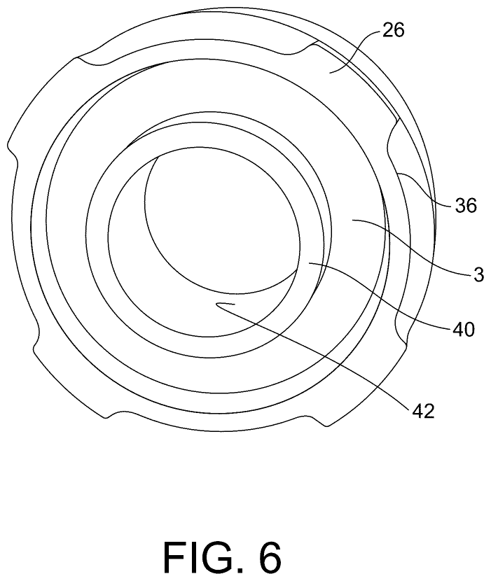

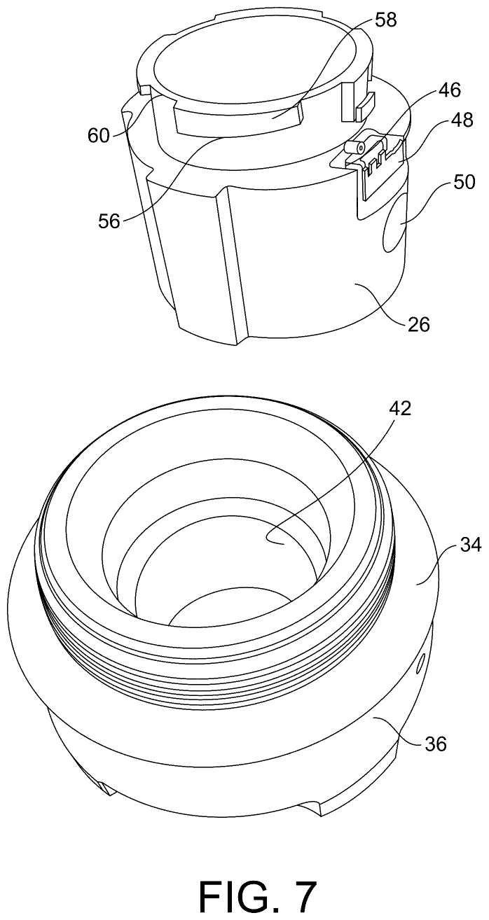

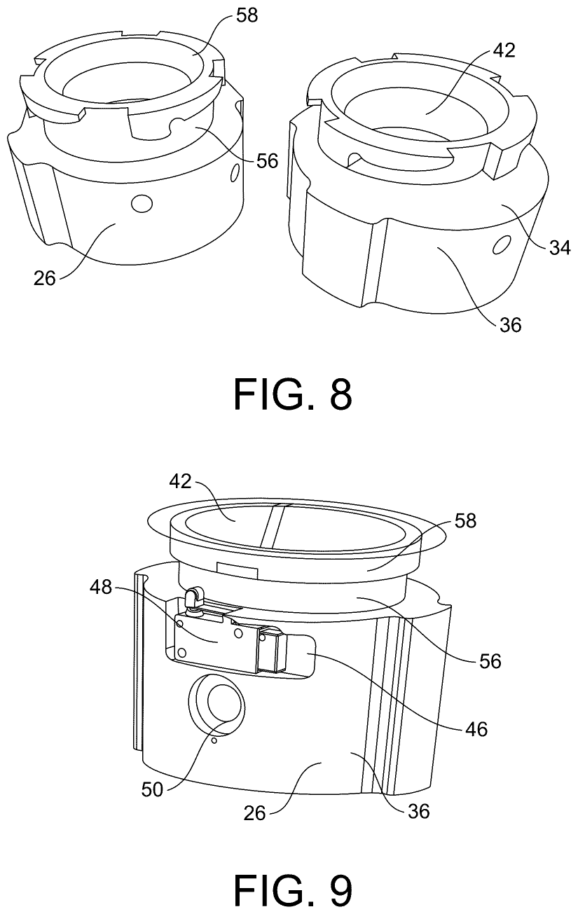

A dosing system 10 of the present invention is illustrated in FIG. 1. The dosing system 10 includes a base unit 12. The base unit 12 is preferably a NEMA electrical enclosure 14. The enclosure 14 is shown with a door 15. The door 15 is made from a UV resistant material to protect additive held within the enclosure and also to allow a user to determine how much additive is within the product reservoir tanks 16, 18 without having to open the door 15. While a clear door 15 is shown, a solid colored door could also be used. Mounted inside enclosure 14 is a PLC controller 20. PLC controller 20 controls all of the function of the dosing system 10 and all electrical components are connected thereto. The enclosure 14 of base unit 12 includes product reservoir tanks 16, 18 and pumps 22, 24 mounted inside enclosure 14 but a larger reservoir of any size may be used, positioned outside of the enclosure 14. Pumps 22, 24 are electric and are controlled by PLC controller 20. One or more filters could also be used to filter the additive as it is pumped from reservoir tanks 16, 18.

Dosing system 10 also includes a dynamic fill adapter 26. Dynamic fill adapter 26, as illustrated in the figures, is configured to be fitted over the existing filler neck of a vehicle fuel tank. Dosing system 10 also includes an umbilical cord 32 that extends from the enclosure 14 to the dynamic fill adapter 26 or adapters. Dosing system 10 preferably has one umbilical cord 32 per dynamic fill adapter 26 and both umbilical cords 32 are connected to enclosure 14. Spring loaded or other types of check valves can be used with the umbilical cords 32 to prevent unwanted siphoning of additive from storage tanks. Product delivery and dynamic fill adapter 26 sensor input wiring are contained within umbilical cord 32. The system may include additional umbilical cords 32 attached to the enclosure 14 to facilitate other fill location, other sensor locations, or other sensors, or other trigger locations.

Dynamic fill adapter 26 of dosing system 10 is configured to be attached to the existing filler neck of a vehicle fuel tank. Attachment of dynamic fill adapter 26 can be by threading dynamic fill adapter 26 onto existing threads formed of the filler neck of the vehicle fuel tank. Alternatively dynamic fill adapter 26 can be clamped onto filler neck of the vehicle fuel tank by use of set screws or other fasteners. In addition to set screws, band clamps or other fastening devices can be used to secure dynamic fill adapter 26 to the filler neck of the vehicle fuel tank.

Dynamic fuel adapter 26 includes a base portion having a top wall 34 and an annular side wall 36 extending downward from the top wall 34. Top wall 34 and annular side wall 36 form an interior recess 38. Interior recess 38 is configured to be fitted over the filler neck of the vehicle fuel tank. Interior recess 38 may include threads that match threads of the filler neck so that dynamic fuel adapter 26 can be screwed onto the filler neck of the vehicle fuel tank. Side wall 36 can also include set screws that pass through side wall 36 to allow dynamic fuel adapter 26 to be clamped onto the filler neck of the vehicle fuel tank. Dynamic fuel adapter 26 also may include an annular inner skirt 40 that is positioned radially inward of side wall 36. Inner skirt 40 extends downwardly from top wall 34 and is formed to include a central bore 42. Central bore 42 is dimensioned to allow for the passage of a fuel nozzle from a commercial fuel station. Dynamic fuel adapter 26 also includes a cap 44. Cap 44 is configured to be coupled to fuel adapter 26 to seal adapter.

Side wall 36 of fuel adapter 26 is formed to include a recess 46, as illustrated in FIG. 9. Recess 46 is configured to accept fuel cap contact switch 48. Contact switch 48 is an on/off switch that is triggered by the removal of cap 44. Removal of cap 44 activates switch so that controller 20 knows that the cap 44 has been removed and that a dose of additive from reservoir tank 16 should be added to fuel tank 30. Bottom edge of cap 44 engages and pushes contact of switch 48 downward to complete the circuit. Side wall 36 of fuel adapter 26 also include a port 50. Umbilical cord 32 is configured to be coupled to port 50 to allow for additive from reservoir tank 16 to be pumped into fuel adapter 26.

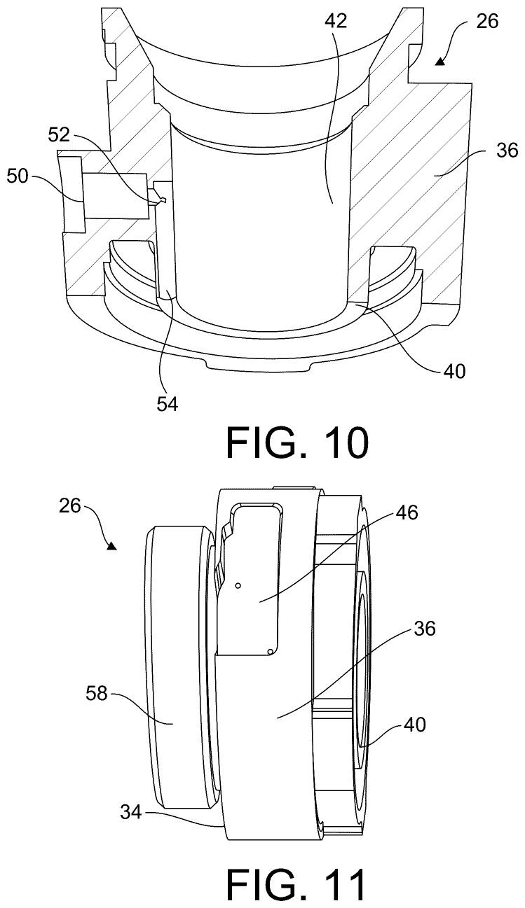

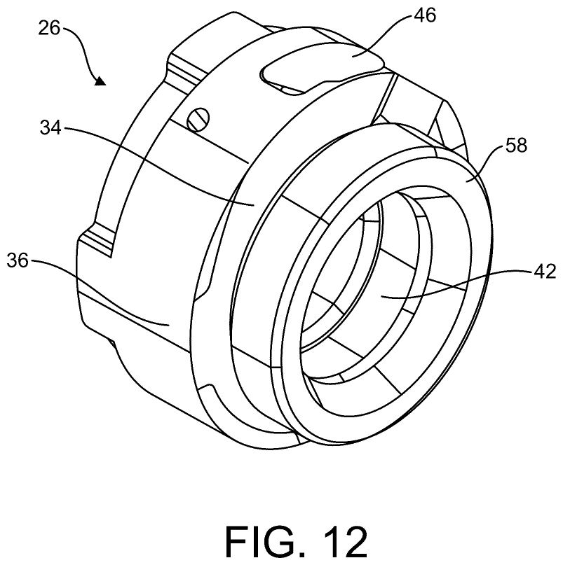

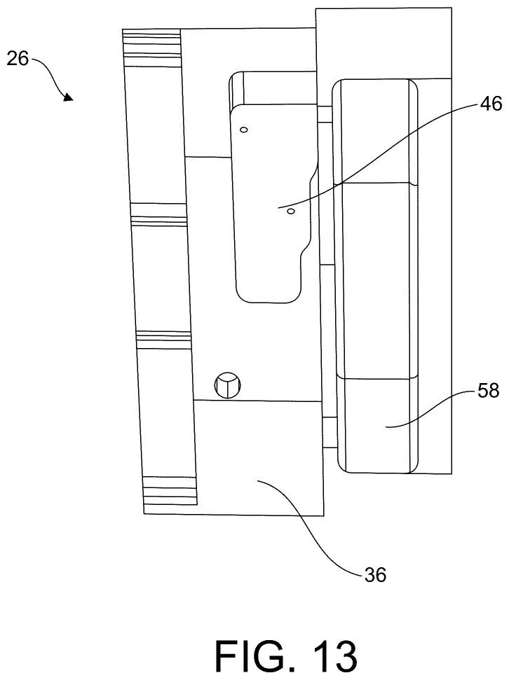

Fuel adapter 26 also includes an internal passageway 52, as shown in FIG. 10. Passageway 52 is coupled to port 50 at a first end and passes through inner skirt 40 to allow additive to flow from port 50, through passageway 52 and out of an opening 54 at a bottom edge of inner skirt 40. Passageway 52 includes a first leg 56 connected to port 50 and a second leg 58 that is connected to opening 54. Second leg 58 runs parallel with central bore 42 of fuel adapter 26. With this arrangement, additive entering through port 50 does not interfere with the flow of fuel or the fuel nozzle through central bore 42.

Dynamic fuel adapter 26 includes a neck portion 56 above top wall 34 and an annular flange 58 located above neck portion 56. Annular flange 58 may include slots 60 that are configured to allow for tabs on cap 44 to pass through slots 60 and engage an underside of annular flange 58 to secure the cap 44 to fuel adapter 26. Alternatively, Annular flange 58 may be replaced with threads so that cap 44 can be screwed onto dynamic fuel adapter 26.

Umbilical cord 32 is adapted to be coupled to enclosure 14 of base unit 12 at a first end and to dynamic fill adapter 26 at a second end. Umbilical cord 32 includes a tube that is coupled to pump 22 at a first end and to port 50 of dynamic fuel adapter 26 at a second end by use of a fitting. Umbilical cord 32 also includes wiring that is connected to controller 20 at a first end and to switch 48 on dynamic fuel adapter 26 at a second end. Umbilical cord 32 can be any length needed to couple dynamic fuel adapter 26 to base unit 12 and dosing system 10 includes one umbilical cord 32 per dynamic fuel adapter 26.

This non-invasive fuel treatment device automatically and effortlessly injects any additive into vehicle or stationary fuel tanks when the fuel cap 44 of dynamic fuel adapter 26 is removed. Simply attach the dosing unit 10 to the vehicle or the stationary tank support framing using fasteners. The pre-dosing unit 10 accommodates any size fuel tank 30 including trucks fitted with varied sized saddlebacks, and holds enough product to last between oil changes. Drivers do not need to be involved in the dosing process in any way.

Dosing unit 10 can be mounted and utilized on a mobile vehicle or mounted and utilized in a stationary setup with stationary tanks and in fuel refineries. Dosing unit 10 can dose any liquid and can dose using timer base volume control or can utilize ultrasonic sensors, hydrostatic sensors, float sensors, laser or light sensors to determine fuel level. In the preferred embodiment, once cap 44 is removed from dynamic fuel adapter 26, controller 20 receives a signal that cap 44 has been removed and it begins dosing additive through umbilical cord 32 into fuel adapter 26. Controller 20 can be set to add enough additive to treat a fuel tank that is 20% full before refueling, for example. In this situation, the controller 20 will dose enough additive to treat the 80% of fuel to be added to the fuel tank.

Umbilical cords 32 can be customized to any length required and dosing system 10 can use any number of umbilical cords 32 required. Umbilical cords 32 are adjustable or custom built to accommodate any volumetric flow rate required and include a check valve to prevent the backflow of additive. The check valve ensures that the umbilical cord 32 remains primed so that the proper amount of additive is added each time the fuel tank is refilled.

Dosing pumps 22, 24 can be adjustable or custom tailored for any volumetric flow rate required. Dosing unit 10 can be designed to accommodate dosing of any number of individual products or mixed products and can be triggered to dose by tank filler cap 44 removal. Triggering can also be caused by use of a volumetric sensor, fill level sensor, or by any aspect of the vehicle electrical or computer system or systems. For example, the system can obtain fuel level information from the vehicle fuel sending unit directly or through the vehicle's OBD port.

Dosing unit 10 can provide additive through any pre-provided OEM orifice in addition to using the dynamic fill adapter 26. Alternatively, they system can use custom drilled orifices if desired. Dynamic fill adaptors 26 are designed to trigger dosing by any combination of, fill cap removal, sensor input, timer input, manual input, or any vehicle or stationary tank electrical system or computer oriented control system such as the OBD port.

Dynamic fill adapters 26 can be utilized singularly or in combination with any number of dynamic fill adaptors, the configuration of which can additionally be utilized to dose single fuel tanks or multiple fuel tanks connected together, or independent, whereas each dynamic fill adaptor can be configured to dose the same additive product or each a different additive products, all dosing the same amount of additive or each dosing a different amount of additive. Dosing unit 10 can be utilized singularly or with multiple fill necks on a single tank or tanks and is designed to attach to a tank either by use of any pre-existing fill cap mounting system or can be provided with a fill neck universal mounting design. The system can be configured to utilize any combination of the OEM fill neck threads for fill cap attachment to mount dynamic fill adaptor 26 or can mount via a universal neck mount with cap 44 or utilize the existing OEM fuel cap. Dynamic fill adaptors 26 may be used to both trigger the dosing charge and inject the dosing charge or in any combination thereof.

The dosing system is for use with a motor vehicle having a fuel tank. The dosing system is used to dose a desired amount of additive into the fuel tank of the motor vehicle. The dosing system includes a controller, a reservoir configured to contain the additive, a pump fluidly coupled to the reservoir and is configured to transfer additive from the reservoir. The controller, reservoir and pump are all contained in a housing. The system also includes a fill adapter that is configured to be attached to the fuel tank of the motor vehicle and is fluidly coupled to the pump. The system further includes a controller that, after receiving a signal from the fill adapter, is configured to dispense a predetermined amount of additive from the reservoir, through the fill adapter and into the fuel tank of the motor vehicle.

The fill adapter is configured to be coupled to a filler neck of the fuel tank of the motor vehicle and includes a base portion having a top wall and an annular side wall extending downward from the top wall, the top wall and the annular side wall form an interior recess, the interior recess is configured to be secured to the filler neck of the fuel tank. The fill adapter includes an annular inner skirt that is positioned radially inward of the side wall. The inner skirt extends downwardly from the top wall and is formed to include a central bore to form an opening that is dimensioned to allow for the passage of a fuel nozzle. The fill adapter also includes a cap or other closure that is configured to be coupled to the fill adapter to seal the opening. The fill adapter includes a contact switch that is triggered by removal of the closure from the fill adapter.

Triggering of the contact switch provides a signal to the controller to dispense a predetermined amount of the additive from the reservoir, through the fill adapter and into the fuel tank of the motor vehicle. The fill adapter also includes a port that is coupled to a passageway that extends from the sidewall to the central bore. The additive from the reservoir is permitted to flow from the port, through the passageway, and out of an opening formed at a bottom edge of an inner skirt. The passageway includes a first leg that is connected to the port and a second leg that is connected to the opening. The second leg runs parallel with the central bore of the fill adapter so that additive entering through the passageway does not interfere with the flow of fuel through the central bore.

The dosing further including an umbilical cord that extends from the housing to the fill adapter. The umbilical cord is configured to allow for the passage of additive from the reservoir to the fuel tank of the motor vehicle. The dosing fill adapter that is configured to be coupled to a filler neck of a fuel tank of a motor vehicle. The dosing fill adapter includes a base portion having a top wall and an annular side wall extending downward from the top wall. The top wall and the annular side wall form an interior recess that is configured to be secured to the filler neck of the fuel tank.

The fill adapter includes an annular inner skirt that is positioned radially inward of the side wall. The inner skirt extends downwardly from the top wall and is formed to include a central bore to form an opening that is dimensioned to allow for the passage of a fuel nozzle. The fill adapter also includes a cap or other closure that is configured to be coupled to the fill adapter to seal the opening. The fill adapter includes a contact switch that is triggered by removal of the closure from the fill adapter. The fill adapter also includes a port that is coupled to a passageway that extends from the sidewall to the central bore. The additive from the reservoir is permitted to flow from the port, through the passageway, and out of an opening formed at a bottom edge of an inner skirt. The passageway includes a first leg that is connected to the port and a second leg that is connected to the opening. The second leg runs parallel with the central bore of the fill adapter so that additive entering through the passageway does not interfere with the flow of fuel through the central bore.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A dosing system for use with a motor vehicle having a fuel tank for dosing an additive into the fuel tank of the motor vehicle, the dosing system comprising:
a reservoir configured to contain the additive;
a pump fluidly coupled to the reservoir, the pump configured to transfer additive from the reservoir;
a fill adapter that is configured to be attached to the fuel tank of the motor vehicle, the fill adapter fluidly coupled to the pump;
a controller is configured to dispense a predetermined amount of additive from the reservoir, through the fill adapter and into the fuel tank of the motor vehicle prior to or while the fuel tank being filled.

2. The dosing system of claim 1, wherein the fill adapter is configured to be coupled to a filler neck of the fuel tank of the motor vehicle.

3. The dosing system of claim 2, wherein the fill adapter includes a base portion having a top wall and an annular side wall extending downward from the top wall, the top wall and the annular side wall form an interior recess, the interior recess is configured to be secured to the filler neck of the fuel tank.

4. The dosing system of claim 3, wherein the fill adapter includes an annular inner skirt that is positioned radially inward of the side wall, the inner skirt extends downwardly from the top wall and is formed to include a central bore to form an opening that is dimensioned to allow for the passage of a fuel nozzle.

5. The dosing system of claim 4, wherein the fill adapter includes a closure that is configured to be coupled to the fill adapter to seal the opening.

6. The dosing system of claim 5, wherein the fill adapter includes a contact switch that is triggered by removal of the closure from the fill adapter.

7. The dosing system of claim 6, wherein triggering of the contact switch provides a signal to the controller to dispense the predetermined amount of the additive from the reservoir, through the fill adapter and into the fuel tank of the motor vehicle.

8. The dosing system of claim 4, wherein the fill adapter includes a port that is coupled to a passageway that extends from the sidewall to the central bore.

9. The dosing system of claim 8, wherein the additive from the reservoir is permitted to flow from the port through the passageway and out of an opening formed at a bottom edge of an inner skirt.

10. The dosing system of claim 9, wherein the passageway includes a first leg that is connected to the port and a second leg that is connected to the opening wherein the second leg runs parallel with the central bore of the fill adapter so that additive entering through the passageway does not interfere with the flow of fuel through the central bore.

11. The dosing system of claim 1, further including a housing, that is configured to contain the reservoir, the pump and the controller.

12. The dosing system of claim 11, further including an umbilical cord that extends from the housing to the fill adapter and is configured to allow for the passage of additive from the reservoir to the fuel tank of the motor vehicle.

13. A dosing fill adapter that is configured to be coupled to a filler neck of a fuel tank of a motor vehicle, the dosing fill adapter comprising:
a base portion having a top wall and an annular side wall extending downward from the top wall, the top wall and the annular side wall form an interior recess, the interior recess is configured to be secured to the filler neck of the fuel tank;
an annular inner skirt that is positioned radially inward of the side wall, the inner skirt extends downwardly from the top wall and is formed to include a central bore to form an opening that is dimensioned to allow for the passage of a fuel nozzle.

14. The dosing fill adapter of claim 13, further including a closure that is configured to be coupled to the fill adapter to seal the opening.

15. The dosing fill adapter of claim 14, wherein the fill adapter includes a contact switch that is triggered by removal of the closure from the fill adapter.

16. The dosing fill adapter of claim 14, wherein the fill adapter includes a contact switch that is triggered by inserting the fuel nozzle into the opening of the fill adapter.

17. The dosing fill adapter of claim 16, wherein the fill adapter includes a port that is coupled to a passageway that extends from the sidewall to the central bore.

18. The dosing fill adapter of claim 17, wherein the passageway includes a first leg that is connected to the port and a second leg that is connected to the opening wherein the second leg runs parallel with the central bore of the fill adapter so that additive entering through the passageway does not interfere with the flow of fuel through the central bore.

19. A dosing system for use with a motor vehicle having a fuel tank for dosing an additive into the fuel tank of the motor vehicle, the dosing system comprising:
a housing configured to be secure to a motor vehicle;
a controller located within the housing;
a reservoir configured to contain the additive, the reservoir positioned within the housing;
a pump fluidly coupled to the reservoir, the pump configured to transfer additive from the reservoir;
a fill adapter that is configured to be attached to the fuel tank of the motor vehicle, the fill adapter fluidly coupled to the reservoir and electrically connected to the controller;
the controller, after receiving a signal from the fill adapter, is configured to dispense a predetermined amount of additive from the reservoir, through the fill adapter and into the fuel tank of the motor vehicle.

20. The dosing system of claim 19, further including an umbilical cord that is configured to be fluidly connected to the pump and the fill adapter and further including wiring to electrically connect the fill adapter to the controller.
